(19) United States
(12) Patent Application Publication
(10) Pub. No.: US 2007/0130065 A1
(43) Pub. Date: Jun. 7, 2007

(54) METHODS AND SYSTEM FOR INCENTIVE MAXIMIZER AGGREGATION ACCOUNT AND AUTOMATIC BALANCE TRANSFER

(75) Inventors: William Christopher Staab, Alexandria, VA (US); Derek Allen Webster, Irvine, CA (US)

Correspondence Address: CONLEY ROSE, P.C., P. O. BOX 3267, HOUSTON, TX, 77253-3267, US

(73) Assignee: E*TRADE Bank, Rancho Cordova, CA (US)

(21) Appl. No.: 11/566,889

(22) Filed: Dec. 5, 2006

Related U.S. Application Data
(60) Provisional application No. 60/742,247, filed on Dec. 5, 2005.

(51) Int. Cl. G06Q 40/00

(52) U.S. Cl. 705/39

(57) ABSTRACT

A method and system are provided for enrolling an external account having an account identifier in an incentive maximizer account, receiving a credential for the external account, and receiving a payment preference for the external account. The method includes periodically accessing external account to detect presence of new account activity. If new account activity is detected, a balance transfer to the external account from the incentive maximizer account is scheduled automatically based on the payment preference.

### PRIORITY

This application claims priority to U.S. Provisional Patent Application Ser. No. 60/742,247, filed Dec. 5, 2005, entitled “Methods and System for E*Trade Mileage Maximizer Aggregation Account and Automatic Balance Transfer,” which is incorporated by reference in its entirety.

### CROSS-REFERENCE TO RELATED APPLICATIONS

None

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Many credit card companies and financial institutions offer rewards associated with use of their lines of credit or bank accounts, such as airline miles or reward dollars. Such incentives are used to increase customer loyalty and encourage use of credit.

Customers use credit in order to earn such incentives, however, many customers wish to transfer or pay off the balance once the reward is earned in order to avoid paying high interest rates or potentially affect their credit rating by carrying a high balance.

Prior to the invention of this disclosure, when a customer wished to transfer a balance from a high interest, reward-earning credit account, the customer would need to contact the issuer of the credit card. For example, the customer call the issuer to arrange an electronic transfer of funds, or utilize a balance transfer coupon from the issuer to whom she is transferring the balance and send it to the issuer from whom she wishes to transfer the balance (i.e., using a convenience check, or the like). Each month, when the high interest, reward earning card statement arrives, the customer repeats the balance transfer process manually.

Software tools and systems can facilitate the task of aggregating various credit accounts and automating the balance transfer system to assist customers in managing their incentive-earning credit accounts while minimizing high interest rate payments.

### SUMMARY

These and other features and advantages will be more clearly understood from the following detailed description taken in conjunction with the accompanying drawings and claims.

A method and system are provided for enrolling an external account having an account identifier in an incentive maximizer account, receiving a credential for the external account, and receiving a payment preference for the external account. The method includes periodically accessing external account to detect presence of new account activity. If new account activity is detected, a balance transfer to the external account from the incentive maximizer account is scheduled automatically based on the payment preference.

In an embodiment, a system is provided. The system includes a means for enrolling an external account having an account identifier, a means for receiving a credential for the external account, and a means for receiving a payment preference for the external account. The system further includes a means for periodically accessing external account to detect presence of new account activity. The system further includes a means for automatically scheduling a balance transfer to the external account based on the payment preference if new account activity is detected.

In an embodiment, a system for incentive maximization and account aggregation is provided. The system includes an account aggregator module, a data aggregator module, and an automatic balance transfer module. The account aggregator module enrolls an external account having an account identifier and receives a credential and a payment preference for the external account. The data aggregator module periodically accesses the external account with the credential to detect new account activity, wherein the data aggregator module is operably coupled to the account aggregator module. The automatic balance transfer module automatically schedules a balance transfer to the external account based on the payment preference if new account activity is detected, wherein the automatic balance transfer module is operably coupled to the account aggregator module and the data aggregator module.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of a system for account aggregation, incentive maximization, and generation of automatic balance transfers in accordance with an embodiment of the present disclosure.

FIG. 2 is a flowchart for a method of account aggregation, incentive maximization, and generation of automatic balance transfers in accordance with an embodiment of the present disclosure.

FIG. 3 is a flowchart for a method of use of account aggregation, incentive maximization, and generation of automatic balance transfers in accordance with an embodiment of the present disclosure.

FIG. 4 is an illustrative screen shot for adding an issuer to an incentive maximizer account in accordance with an embodiment of the present disclosure.

FIG. 5 is an illustrative screen shot for enrollment in an automatic balance transfer program in accordance with an embodiment of the present disclosure.

FIG. 6 is an illustrative screen shot for entering automatic account balance transfer preferences in accordance with an embodiment of the present disclosure.

FIG. 7 is an illustrative screen shot for confirming automatic account balance transfer preferences entered in a screen of FIG. 4 in accordance with an embodiment of the present disclosure.

FIG. 8 is an illustrative screen shot for an account alert sent to the customer upon the automatic scheduling of a balance transfer in accordance with an embodiment of the present disclosure.

FIG. 9 is an illustrative screen shot for a pending transfer in accordance with an embodiment of the present disclosure.

FIG. 10 is an illustrative screen shot for an account alert sent to the customer upon the automatic processing of a balance transfer in accordance with an embodiment of the present disclosure.

FIG. 11 illustrates an exemplary general purpose computer system suitable for implementing embodiments of the present disclosure.

### DETAILED DESCRIPTION

It should be understood at the outset that although an illustrative implementation of one embodiment of the present disclosure is illustrated below, the present system may be implemented using any number of techniques, whether currently known or in existence. The present disclosure should in no way be limited to the illustrative implementations, drawings, and techniques illustrated below, including the exemplary design and implementation illustrated and described herein, but may be modified within the scope of the appended claims along with their full scope of equivalents.

The incentive maximizer account is a specialized line of credit which enables a customer to consolidate some or all of her reward-earning credit accounts, transfer the balance of her various accounts, and handle those balance transfer payments on an automated basis without requiring the customer to return to the site or make balance transfers manually.

The automatic balance transfer system is a tool used by the incentive maximizer account to consolidate balances on reward-earning accounts to the incentive maximizer account on an automated basis.

Generally speaking, a customer voluntarily provides access credentials for an external account or set of accounts though her incentive maximizer account. These credentials are stored in an encrypted format and, on the customer's behalf, the Automatic Balance Transfer system works with a data aggregation system to log into the data source site(s) associated with the issuer of the external account and retrieve all appropriate account data, such as balance, minimum payment amount, payment due date, and the like. This account data is accessible through the incentive maximizer. The automatic balance transfer system automates a check of each account for each customer on a periodic basis, such as every night, in order to check for new account balances, and generate a balance transfer in the event of new account activity that has occurred since the last account check or the last balance transfer.

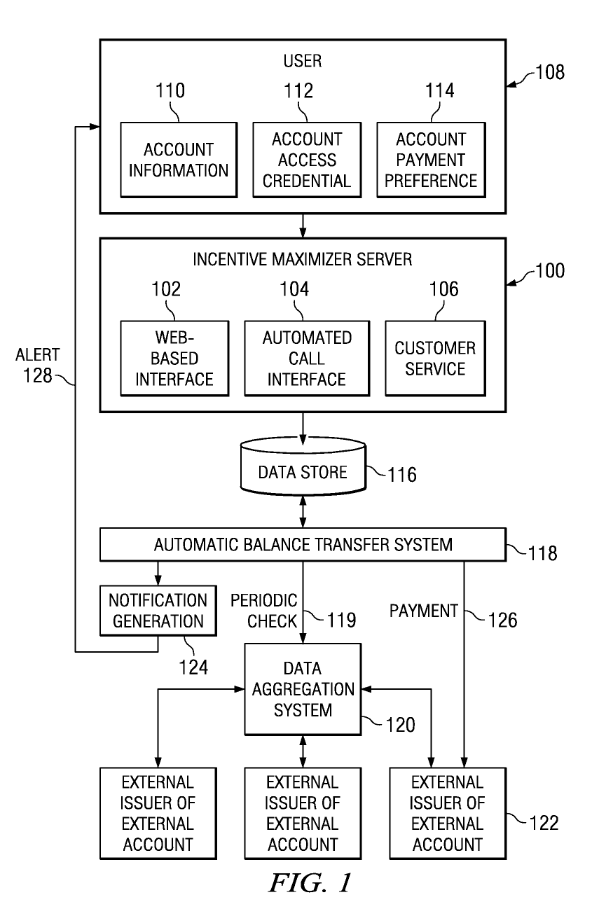

FIG. 1 is a block diagram of a system for account aggregation, incentive maximization, and generation of automatic balance transfers. The system includes an incentive maximizer server 100 that receives various inputs from a user 108, and stores the inputs in a data store 116. The data store 116 is accessible to an automatic balance transfer system 118.

The inputs from the user 108 include account information 110 such as an account identifier and the identity of an external issuer that holds the external account. The inputs from the user 108 also include account access credentials 112 for the external account, such as a user name and pass code for accessing the external account. The inputs from the user 108 also include account payment preferences 114 that establish whether the user 108 prefers to manually or automatically generate balance transfers, the amount and scheduling of any automatic balance transfers, and the like.

The incentive maximizer server 100 may include a web-based interface 102, by which the user 108 may enroll himself. The incentive maximizer server 100 may additionally include an automated call interface by which the user 108 may enroll himself without a computer. The incentive maximizer server 100 may additionally include a customer service interface 106 by which the user 108 may receive assistance with enrollment from a customer service representative. The incentive maximizer server 100 receives the account information 110, the account access credential 112, and the account payment preferences 114 from the user 108 through any of the various interfaces, and stores the inputs in the data store 116. The inputs may be encrypted for security purposes.

The inputs stored in the data store 116 are accessible by the automatic balance transfer system 118. The automatic balance transfer system 118 may verify the inputs, such as checking with the external issuer for the existence of an external account identified by the account information 110, and confirming with the external issuer that the provided account access credentials 112 are the correct credentials used for accessing the external account. Verification may be performed directly by contacting the external issuer of the account, or via an intermediate data aggregation system 120.

In an embodiment, the automatic balance transfer system 118 is coupled to the data aggregation system 120, though alternatively, the data aggregation system 120 may be incorporated into the automatic balance transfer system 118. The automatic balance transfer system 118 provides the inputs stored in the data store 116 to the data aggregation system 120, which in turn accesses the external account with the external issuer 122. The data aggregation system 120 accesses the external account by providing to the external issuer 122 the account information 110 (such as the user's identity, the account identifier (i.e., account number), and the account access credentials 112. The data aggregation system 120 may additionally be used in verifying the inputs. The data aggregation system 120 may access accounts held with a plurality of external issues, as shown in FIG. 1.

By accessing the external account, the data aggregation system 120 can detect whether new activity has posted to the external account. New activity may include any activity posted to the external account in a present billing cycle, any activity posted to the external account since the last check performed by the data aggregation system 120, or any activity posted to the external account ever for newly enrolled accounts. The automatic balance transfer system 118 periodically prompts the data aggregation system 120 to perform a periodic check 119 for new activity. The periodic check 119 may be performed, for example, each night, each billing cycle, or otherwise periodically as determined by the enterprise managing the system.

If the periodic check 119 detects new activity posted to the external account, the data aggregation system 120 gathers payment information from the external issuer 122, such as the new balance on the external account, the minimum payment, and the due date for the payment. The data aggregation system 120 provides the payment information from the external issuer 122 to the automatic balance transfer system 118.

The automatic balance transfer system 118 schedules a balance transfer payment 126 to the external issuer 122 based on the payment information and the account payment preferences 114. For example, if the payment information indicates that new activity results in a balance of $100 and the minimum payment is $25 due on the first of the month, and, for example, the account payment preferences 114 indicate that the user 108 wishes for full payment to be made prior to the due date, then automatic balance transfer system 118 schedules a balance transfer payment 126 for $100 to be made on a predetermined date prior to the first of the month. Likewise, if the account payment preferences 114 indicate that the user 108 wishes for the minimum payment to be paid on the due date, then the automatic balance transfer system 118 schedules a balance transfer payment 126 for $25 to be made on the first of the month.

The automatic balance transfer system 118 is additionally coupled to (or integrated with) a notification generation component 124 operable to generate an alert 128 to the user 108 upon the scheduling of a balance transfer payment 126. Upon such an alter 128, the user 108 may access the incentive maximizer server 100 to alter the scheduled payment or account payment preferences. For example, the user 108 may wish to manually increase or decrease the amount of the payment, change the payment date, or cancel the payment altogether. The notification generation component 124 is also operable to generate another alert 128 to the user 108 upon the completion of a balance transfer payment 126. The notification generation component 124 may operate by sending an email message, a text message, a message via an internal mailbox within the incentive maximizer server 100, a page, or other forms of electronic or manual notification.

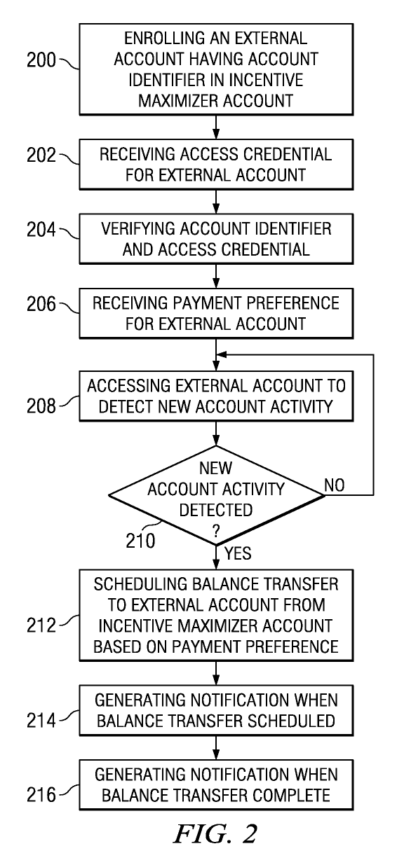

FIG. 2 is a flowchart for a method of account aggregation, incentive maximization, and generation of automatic balance transfers. The method begins with the system of FIG. 1 enrolling an external account having an account identifier in an incentive maximizer account (block 200) which may or may not aggregate the external account with other external accounts. The method proceeds with receiving an account access credential for the external account (block 202). The account access credential is the unique personal information (such as a user name and/or password) that the user uses to access the external account with the issuer of the external account (i.e., to log in to the external issuer's website, etc.)

The method proceeds with verifying the account identifier and account access credential with the external issuer to confirm the existence of the external account and the validity of the provided account access credential (block 204). The method proceeds with receiving a payment preference for the external account (block 206). The account identifier, account access credential, and payment preference are stored. Using the account identifier and account access credential, the external account is accessed (block 208) to detect new account activity in a check (block 210), as defined above. If no new account activity is detected, the method iterates to the next periodic check made, as the system periodically accesses the external account to detect new account activity (block 208).

If new account activity is detected, a balance transfer payment is scheduled to the external account from the incentive maximizer account based on the payment preference (block 212). Upon scheduling, the method proceeds by generating a notification when the balance transfer payment is scheduled (block 214), thereby enabling the user to access the system of FIG. 1 to alter or cancel the scheduled balance transfer payment. The method proceeds with generating a notification when the balance transfer payment is complete, i.e., when the balance transfer payment has been transferred by check, electronic funds transfer, or otherwise, from the incentive maximizer account to the external account (block 216).

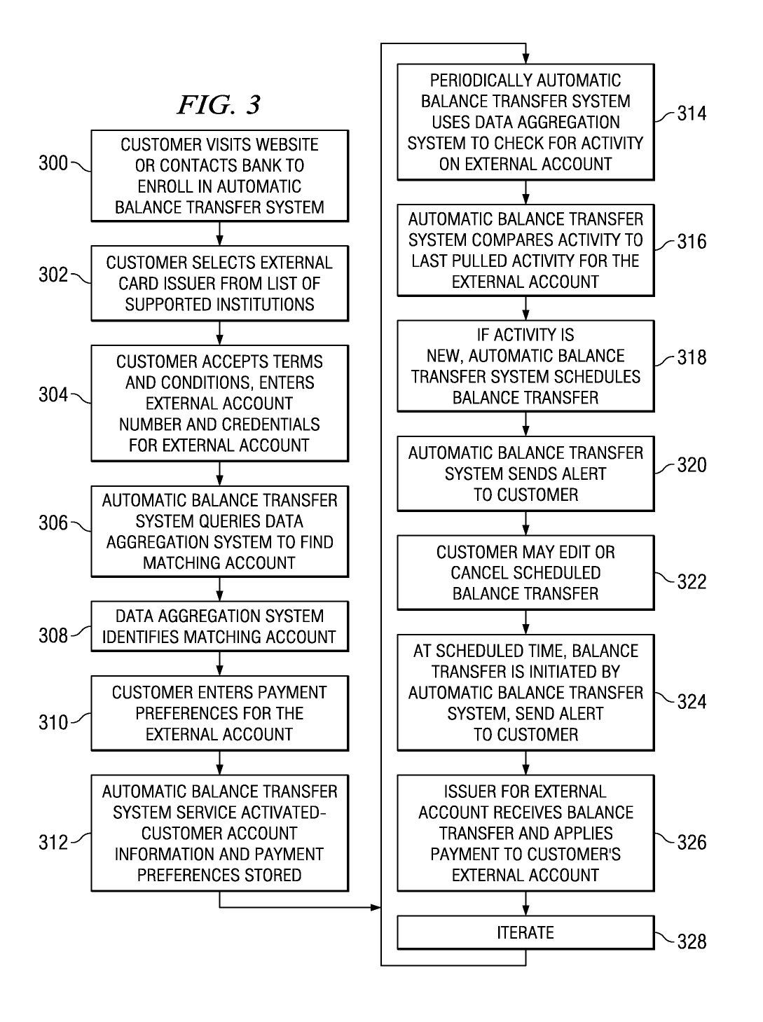

As seen in the flowchart of use of the system and method in FIG. 3, the customer visits the financial institution website or contacts the financial institution to set up the incentive maximizer account. and/or enroll in the automatic balance transfer system (block 300). The incentive maximizer account is set up to aggregate external credit accounts from external issuers with the financial institution. In an embodiment, the financial institution may limit the number of external credit accounts that may be aggregated into the incentive maximizer account. For example, the incentive maximizer account may be limited to aggregating five external accounts. In an embodiment, the incentive maximizer account aggregates the external accounts in order to qualify the customer for a lower interest rate offered by the financial institution, the interest rate being lower than the interest associated with the external credit accounts. In an embodiment, the incentive maximizer account aggregates the external accounts in order to simplify the management of the various external credit accounts for the customer. In an embodiment, the incentive maximizer account aggregates the external accounts in order to eliminate carrying a balance on the external accounts by automatically generating balance transfers as payment upon account activity.

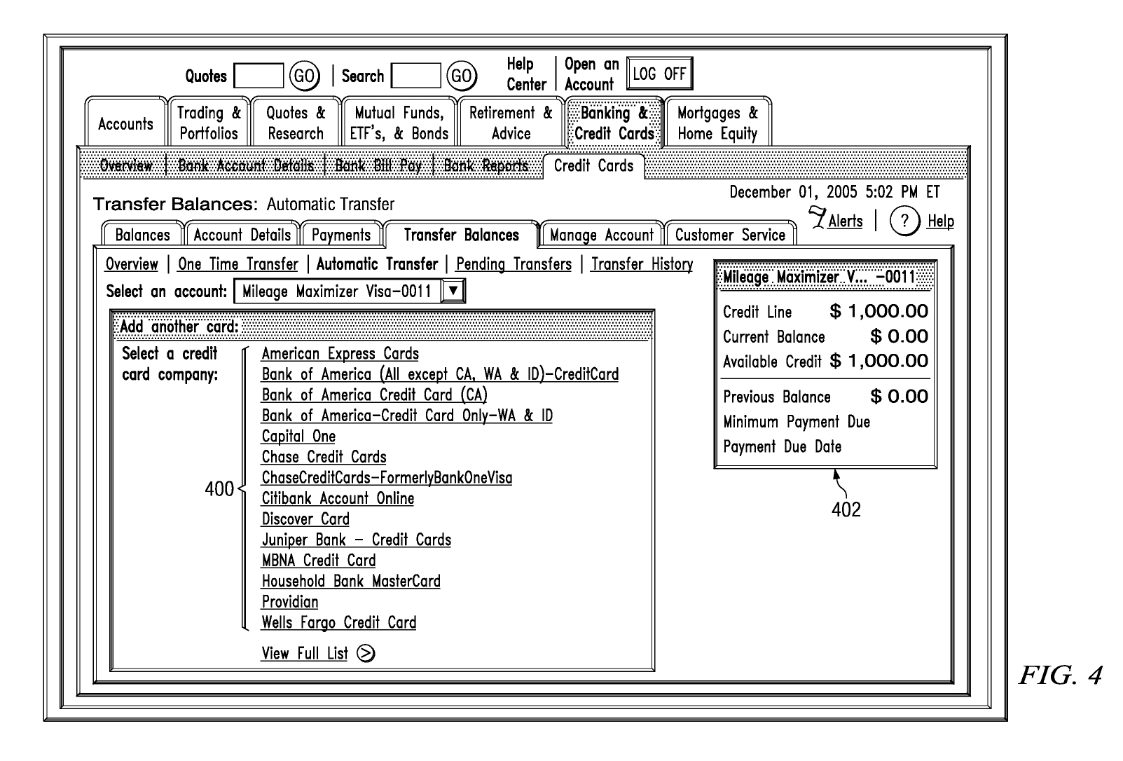

In an embodiment, the incentive maximizer account and automatic balance transfer system may only permit aggregation of external accounts held with preferred issuers. The preferred issuers may be issuers that permit access to their systems through a data aggregator system, which will be discussed in greater detail below. As seen in the exemplary screen display of FIG. 4, a list of preferred issuers (400) is shown from which the customer selects a credit card company (with whom she holds an account, referred to as an external account) to add to her incentive maximizer account. The list, in an embodiment, may comprise a list of hyperlinks from which the customer may choose, or in another embodiment, the list may comprise a drop down menu of selections from which the customer may choose. Also shown in FIG. 4 are details (402) pertaining to the incentive maximizer account to which the customer is adding an external account.

Referring again to FIG. 3, the customer selects an issuer with whom she has an account from the list of supported preferred issuer institutions (block 302). The customer also accepts the terms and conditions pertaining to the incentive maximizer account and the financial institution, and enters her external account number as well as the credentials for her external account (block 304). The credentials are customer identifying information, such as a user name, password, social security number, pin code, or other identifiers commonly used by customers when logging into an issuer's system to access account information. The credentials entered by the customer are those relating to the customer's external account, and comprise the credentials that the issuer of the external account requires for the customer to access the external account.

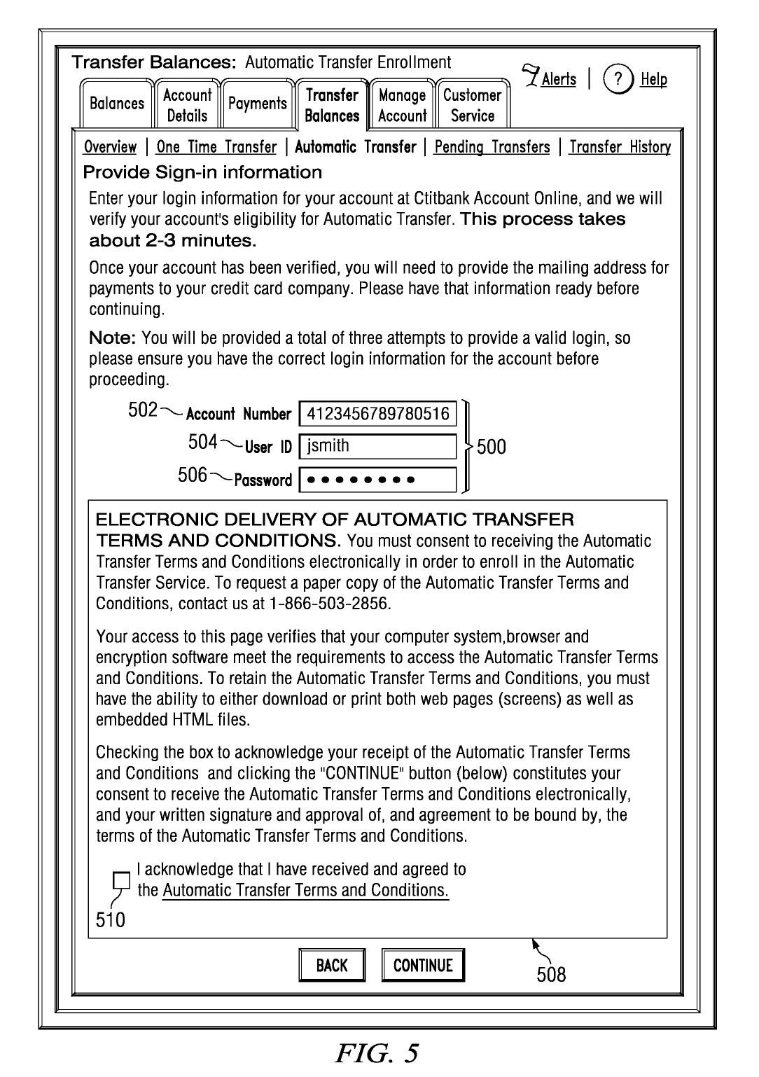

As shown in the exemplary screen display of FIG. 5, the customer provides the credentials for her external account in the verification process. For example, in a series of text boxes (500), the customer provides her account number (502), her user ID (504), and her password for her external account (506) comprising her credentials for log on to the external account. In an embodiment, for security purposes, any credential provided by the customer may be displayed as asterisks or other symbols such that the customer's credentials are not displayed as she types them. For example, in the exemplary screen display of FIG. 5, the customer's password is not displayed as entered, but rather the characters are replaced by a dot symbol for security. The customer also accepts the terms and conditions of the automatic balance transfer system (508). In an embodiment, the customer's assent to the terms and conditions may be indicated by selection of a check box (510) or entry of a pin code representing the customer's signature.

Referring again to FIG. 3, using the external account number and credentials, the automatic balance transfer system queries a data aggregation system to find a matching account (block 306). The data aggregation system identifies a matching account, and returns an identification number (e.g., serial number) for identifying the account with the data aggregation system to the automatic balance transfer system (block 308).

The customer enters payment preferences (described further below) for the external account (block 310). Based on all of the customer provided information, the automatic balance transfer system service is activated, and the customer account information and credentials, serial number identifying the account for the data aggregation system, and payment preferences are stored in the automatic balance transfer system (block 312).

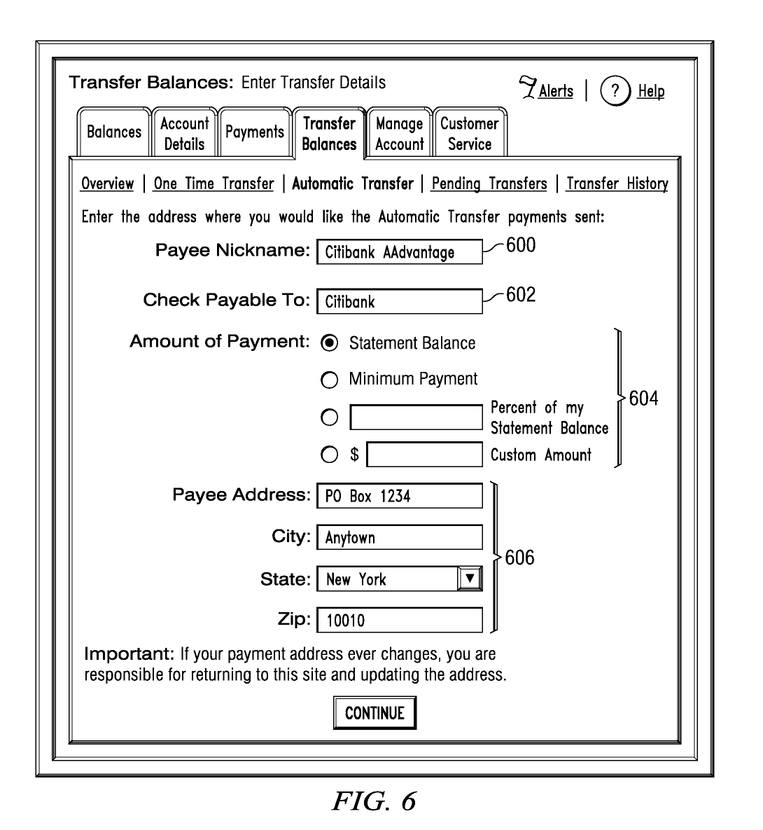

Referring to FIG. 6, an exemplary screen display for the entry of payment preferences is shown. In an embodiment, a series of text boxes, buttons or drop down menus may be used by the customer to enter her payment preferences. In an embodiment, the customer may enter a payee nickname (600) by which to identify her external account from within her incentive maximizer account. Generally, the customer provides the information to be used by the automatic balance transfer system to generate automatic balance transfer payments. In an embodiment, the customer provides the name of the entity to which the payment check should be payable (602), the amount of the payment for each time a balance transfer is made (604), and the payment address where the payment should be sent each time a balance transfer is made (606). In an embodiment, the customer may choose from various amounts of payment. For example, the customer may choose to, each time a balance transfer is made, pay the statement balance, the minimum payment for the statement, a percentage of the statement balance, or some other custom dollar amount as desired by the customer.

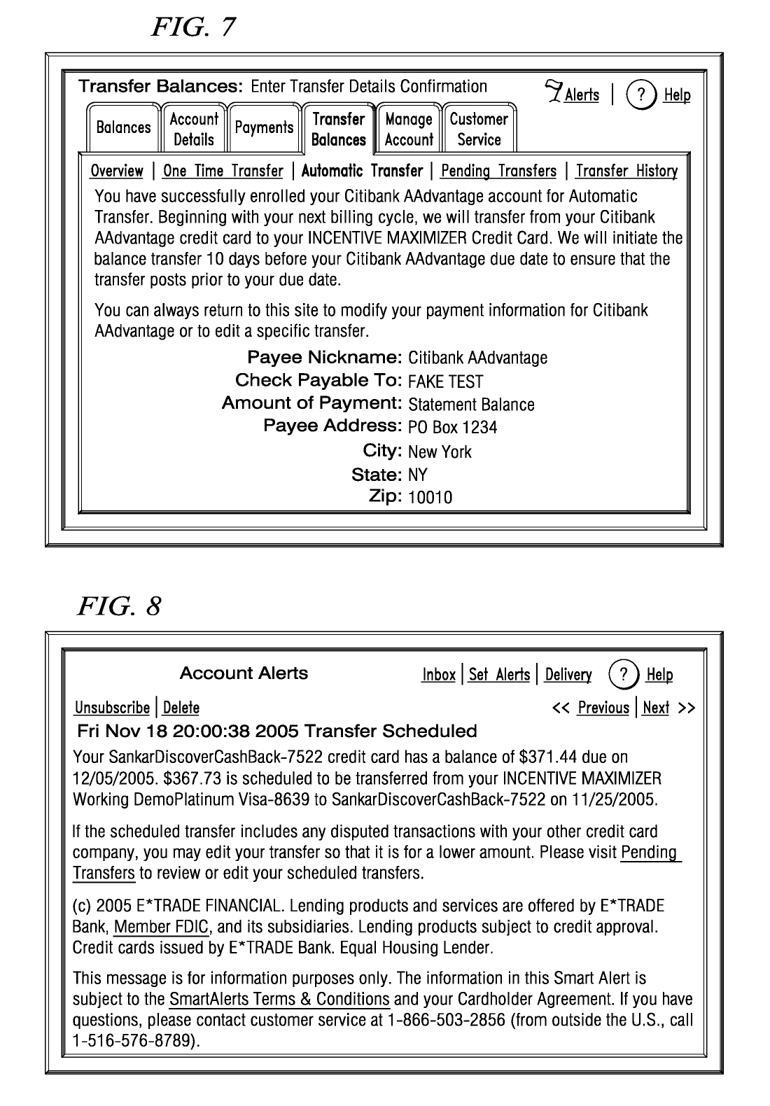

In an embodiment, when the customer has entered in the payment preferences in a screen, for example, similar to that of FIG. 6, a confirmation page may be displayed to her. An exemplary screen display of the confirmation page is shown in FIG. 7. The confirmation page signifies to the customer that the automatic balance transfer system is active for her incentive maximizer account with respect to the external account that she enrolled. The confirmation page also notifies the customer that she may return to the system to update, edit, cancel, or correct any details of the payment preferences.

Referring back to FIG. 3, the automatic balance transfer system periodically uses the data aggregation system to check for any new activity on the external account (block 314). During each periodic check, the automatic balance transfer system compares activity on the external account to the last pulled activity for the external account by the automatic balance transfer system (block 316). If activity on the external account is new (i.e., there is a new balance on the external account since the time of the last check), the automatic balance transfer system schedules a balance transfer based upon the payment preferences (block 318). The automatic balance transfer system sends an alert (for example, by email, instant message, text message, or by mail) to customer indicating the details of the balance transfer (block 320). An exemplary account alert such as that sent to the customer by email upon the automatic scheduling of a balance transfer is shown in FIG. 8. Upon scheduling of a balance transfer by the Automatic Balance Transfer system, the customer may access her incentive maximizer account to edit or cancel the scheduled balance transfer as desired (block 322).

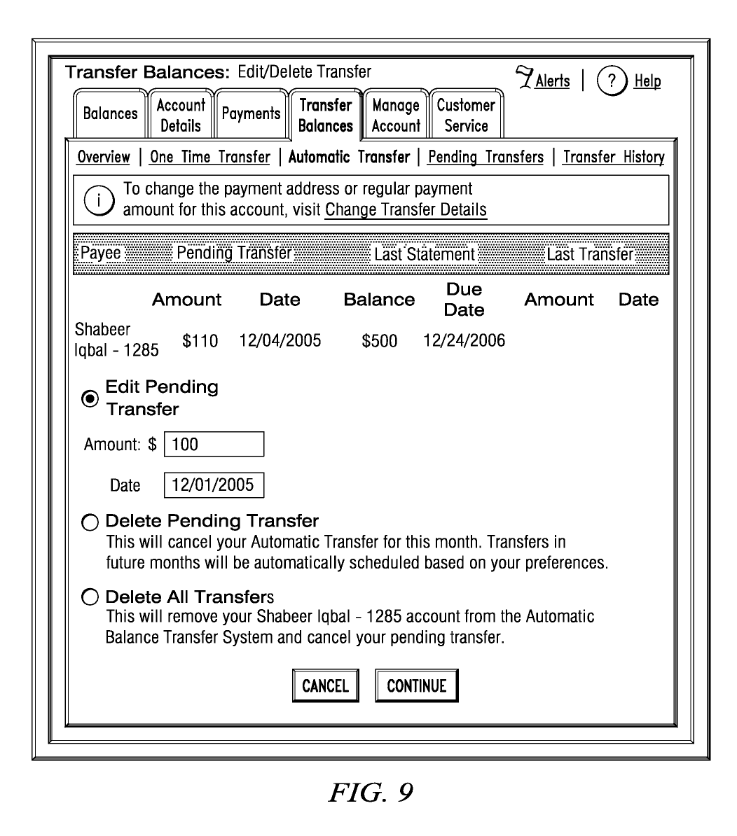

Referring to FIG. 9, an exemplary screen display of a “pending transfer” is shown. The display shows the details of the scheduled balance transfer, such as, for example, the payee, the amount of the scheduled transfer, the date of the scheduled transfer, details of the last statement, such as the balance and the due date, and details of the last balance transfer, such as the amount and the date. In the pending transfer screen, the customer may edit the scheduled balance transfer, by changing the amount or the date. The customer may alternatively delete the scheduled balance transfer entirely. The customer may alternatively delete all transfers, even those not yet scheduled, but removing the external account from the automatic balance transfer system. The pending transfer screen enables the customer to examine balance transfers if she chooses to, but no action is required from her for the automatic balance transfer to be completed if she still wishes for her payment preferences to be exercised automatically for her.

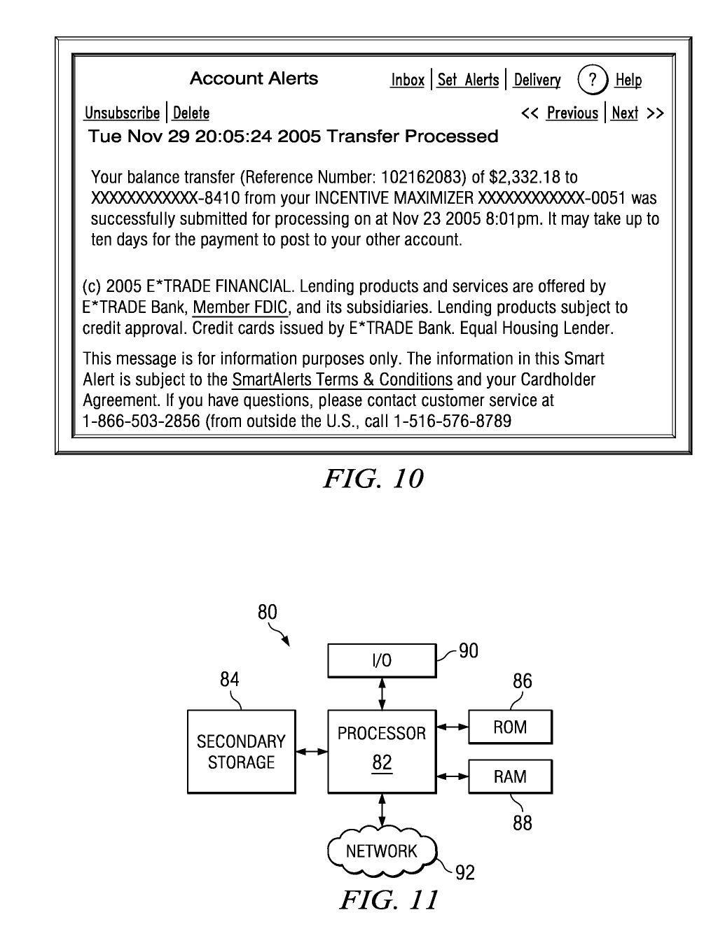

If the customer does not cancel the schedule balance transfer, at the scheduled time, the balance transfer is initiated by the automatic balance transfer system, and a confirming alert is sent to the customer (block 324). The alert may be sent, for example, by email, instant message or by mail. An exemplary account alert such as that sent to the customer upon the automatic processing of a balance transfer is shown in FIG. 10. Based on the initiated balance transfer, the issuer for the external account receives the balance transfer (which may be by way of a check, wire, or electronic funds transfer), and applies payment to customer's external account (block 326). The automatic process iterates (block 328), repeating the periodic checks for new activity on the external account (block 314), and automatically generating balance transfers as programmed according to the payment preferences.

In an embodiment, the incentive maximizer account is accessed using a software tool residing in the financial institution's computer system. The customer logs in via her personal computer to the financial institution's computer system via a network connection and the Internet. The automatic balance transfer system is embodied in a script that executes in conjunction with the data aggregation system. Management of the incentive maximizer account is performed by the customer through the financial institution's web page. Alerts pertaining to automatically scheduled balance transfers are sent either to the customer's email address, or to an alert mailbox maintained within the financial institution's computer system and accessed by the customer when she logs in to the incentive maximizer account.

In an embodiment, data aggregation is performed by a third party. In such a preferred embodiment, a customer voluntarily provides access credentials for an account or set of accounts though her incentive maximizer account. The third party stores these credentials in an encrypted format and, on the customer's behalf, logs into the data source site(s) and retrieves all appropriate account data. The account data is accessible through the incentive maximizer, and the automatic balance transfer system automates a check of each account for each customer on a regular basis, such as every night, in order to check for new account balances, and generate a balance transfer in the event of account activity occurring according to the third party.

The system described above may be implemented on any general-purpose computer with sufficient processing power, memory resources, and network throughput capability to handle the necessary workload placed upon it. FIG. 11 illustrates a typical, general-purpose computer system suitable for implementing one or more embodiments disclosed herein. The computer system 80 includes a processor 82 (which may be referred to as a central processor unit or CPU) that is in communication with memory devices including secondary storage 84, read only memory (ROM) 86, random access memory (RAM) 88, input/output (I/O) 90 devices, and network connectivity devices 92. The processor may be implemented as one or more CPU chips.

The secondary storage 84 is typically comprised of one or more disk drives or tape drives and is used for non-volatile storage of data and as an over-flow data storage device if RAM 88 is not large enough to hold all working data. Secondary storage 84 may be used to store programs which are loaded into RAM 88 when such programs are selected for execution. The ROM 86 is used to store instructions and perhaps data which are read during program execution. ROM 86 is a non-volatile memory device which typically has a small memory capacity relative to the larger memory capacity of secondary storage. The RAM 88 is used to store volatile data and perhaps to store instructions. Access to both ROM 86 and RAM 88 is typically faster than to secondary storage 84.

I/O 90 devices may include printers, video monitors, liquid crystal displays (LCDs), touch screen displays, keyboards, keypads, switches, dials, mice, track balls, voice recognizers, card readers, paper tape readers, or other well-known input devices. The network connectivity devices 92 may take the form of modems, modem banks, ethernet cards, universal serial bus (USB) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network connectivity 92 devices may enable the processor 82 to communicate with an Internet or one or more intranets. With such a network connection, it is contemplated that the processor 82 might receive information from the network, or might output information to the network in the course of performing the above-described method steps. Such information, which is often represented as a sequence of instructions to be executed using processor 82, may be received from and outputted to the network, for example, in the form of a computer data signal embodied in a carrier wave

Such information, which may include data or instructions to be executed using processor 82 for example, may be received from and outputted to the network, for example, in the form of a computer data baseband signal or signal embodied in a carrier wave. The baseband signal or signal embodied in the carrier wave generated by the network connectivity 92 devices may propagate in or on the surface of electrical conductors, in coaxial cables, in waveguides, in optical media, for example optical fiber, or in the air or free space. The information contained in the baseband signal or signal embedded in the carrier wave may be ordered according to different sequences, as may be desirable for either processing or generating the information or transmitting or receiving the information. The baseband signal or signal embedded in the carrier wave, or other types of signals currently used or hereafter developed, referred to herein as the transmission medium, may be generated according to several methods well known to one skilled in the art.

The processor 82 executes instructions, codes, computer programs, scripts which it accesses from hard disk, floppy disk, optical disk (these various disk based systems may all be considered secondary storage 84), ROM 86, RAM 88, or the network connectivity devices 92.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. A method, comprising:
enrolling an external account having an account identifier;
receiving a credential for the external account;
receiving a payment preference for the external account
periodically accessing external account to detect presence of new account activity; and
if new account activity is detected, automatically scheduling a balance transfer to the external account based on the payment preference.

2. The method according to claim 1, further comprising enrolling a customer in an automatic balance transfer system.

3. The method according to claim 1, further comprising verifying the external account and the credential.

4. The method according to claim 1, further comprising generating an alert when the balance transfer is scheduled.

5. The method according to claim 1, further comprising generating an alert when the balance transfer is complete.

6. The method according to claim 1, further comprising receiving an edit to the scheduled balance transfer.

7. The method according to claim 1, further comprising receiving a cancellation of the scheduled balance transfer.

8. The method according to claim 1, wherein the balance transfer is one of a check, an electronic funds transfer, and wire transfer from a bank account or line of credit.

9. A system, the system comprising:
a means for enrolling an external account having an account identifier;
a means for receiving a credential for the external account;
a means for receiving a payment preference for the external account;
a means for periodically accessing external account to detect presence of new account activity; and
a means for automatically scheduling a balance transfer to the external account based on the payment preference if new account activity is detected.

10. The system according to claim 9, further comprising a means for enrolling a customer in an automatic balance transfer system.

11. The system according to claim 9, further comprising a means for verifying the external account and the credential.

12. The system according to claim 9, further comprising a means for generating an alert when the balance transfer is scheduled.

13. The system according to claim 9, further comprising a means for generating an alert when the balance transfer is complete.

14. The system according to claim 9, further comprising a means for editing the scheduled balance transfer.

15. The system according to claim 9, further comprising a means for canceling the scheduled balance transfer.

16. The system according to claim 9, wherein the balance transfer is one of a check, an electronic funds transfer, and wire transfer from a bank account or line of credit.

17. A system for incentive maximization and account aggregation, the system comprising:
an account aggregator module that enrolls an external account having an account identifier and receives a credential and a payment preference for the external account;
a data aggregator module that periodically accesses the external account with the credential to detect new account activity, wherein the data aggregator module is operably coupled to the account aggregator module; and
an automatic balance transfer module that automatically schedules a balance transfer to the external account based on the payment preference if new account activity is detected, wherein the automatic balance transfer module is operably coupled to the account aggregator module and the data aggregator module.

18. The system according to claim 17, the account aggregator module further comprising a web-based interface for receiving the account identifier, the credential, and the payment preference.

19. The system according to claim 17, further comprising a data store operable to store the account identifier and the credential in an encrypted form, ensuring security of the system.

20. The system according to claim 17, wherein the data aggregator module verifies the external account and the credential with an issuer of the external account.

21. The system according to claim 17, wherein the automatic balance transfer module generates an alert when the balance transfer is scheduled.

22. The system according to claim 17, wherein the automatic balance transfer module generates an alert when the balance transfer is complete.
